(19) United States
(12) Patent Application Publication
(10) Pub. No.: US 2020/0254473 A1
(43) Pub. Date: Aug. 13, 2020

(54) Water Fountain Wreath and Process to Make Same

(71) Applicants: MiLisa M. Mercado Manzanares, Clarksville, TN (US); Cynthia Santana, Clarksville, TN (US)

(72) Inventors: MiLisa M. Mercado Manzanares, Clarksville, TN (US); Cynthia Santana, Clarksville, TN (US)

(21) Appl. No.: 16/785,611

(22) Filed: Feb. 9, 2020

Related U.S. Application Data
(60) Provisional application No. 62/803,940, filed on Feb. 11, 2019.

(51) Int. Cl. B05B 17/08; A01G 5/04; A01G 5/02

(52) U.S. Cl. CPC B05B 17/08; F21W 2121/02; A01G 5/02; A01G 5/04

(57) ABSTRACT

The present invention relates to a decorative wreath with a miniature water fountain for household display and the process for making the same.

### CROSS REFERENCE TO RELATED APPLICATIONS

Provisional Patent Application No. 62/803,940

Filing Date: Feb. 11, 2019

Relationship: Provisional application was for same invention.

### STATEMENT REGARDING FEDERALLY SPONSORED RESEARCH OR DEVELOPMENT

This invention was not made by an agency of the United States Government nor under a contract with an agency of the United States Government.

### THE NAME OF THE PARTIES TO JOINT RESEARCH AGREEMENT

Not Applicable.

### INCORPORATION BY REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable

### BACKGROUND OF THE INVENTION

### Field of the Invention

A wreath is an assortment of flowers, leaves, fruits, twigs, or various other materials generally constructed into a ring or circular shape. Wreaths are used typically as household decorations and for funeral and memorials. Although evergreen wreaths are popular Christmas decorations, the usage of wreaths made from a variety of materials as a decorative item is not restricted to holidays.

The present invention includes a water fountain with the wreath and the process for making the same.

### Description of Related Art

Wreaths whether made of flowers, grapevines, evergreen, leaves or various other materials have been used as decorations for years. Wreaths are available commercially in a completed form or can be handcrafted by hobbyist.

Water fountains are generally large architectural features that involve the spill of water into a basin or shooting water jets into the air. Smaller versions are available for household or yard decorations including miniature versions less than 8 inches in height.

### BRIEF SUMMARY OF THE INVENTION

The present invention is a decorative wreath with a miniature water fountain which may include LED lights and the process of making the same.

### BRIEF DESCRIPTION OF THE SEVERAL VIEWS OF THE DRAWING

FIG. 1 is a flow chart outlining the process steps in making the invention.

FIG. 2 is an example of a wreath frame.

FIG. 3 is an example of a miniature water fountain.

FIG. 4 is an example of a completed wreath with a miniature water fountain.

### DETAILED DESCRIPTION OF THE INVENTION

The present invention relates to a decorative wreath with a miniature water fountain for household display and the process for making the same.

The process starts with a wreath frame (10) that serves as the base for the final product. The preferred embodiment of the invention utilizes a commercially available circular metal ring between 12 and 30 inches in diameter. Wreath frames are also available in other shapes and materials. Shapes may include hearts and stars. The wreath fame made be made from wood fiber, polystyrene, or medium density fiberboard (MDF) among other materials.

The second component in the invention is a miniature water fountain (20). Miniature water fountains for indoor use are commercially available in many designs. They are typically under 12 inches in heights with some no higher than 6-7 inches. These water fountains may be battery operated or powered via a cord to an electrical outlet. Some miniature water fountains are equipped with LED lights to enhance their decorative nature.

The miniature water fountain (20) is affixed to the wreath frame (10) using one or more zip tie straps. Although zip tie straps are used in the preferred embodiment of the invention, other means such as an adhesive could be used to affix to the miniature water fountain (20) to the wreath frame (10) depending upon the composition of the wreath frame (10) and the shape of the miniature water fountain (20). The side of the wreath frame (10) to which the miniature water fountain (20) is affixed is herein after referred to as the front side of the wreath. The opposite side of the wreath frame (10) is the back side of the wreath.

Grapevine or other natural covering material (15) is then affixed to the front side of the wreath frame (10). The preferred embodiment of the invention utilizes a grapevine wreath and affixes it to the wreath frame (10) with one or more zip tie straps.

An eye bolt (30) is affixed to the back side of the wreath frame (10) using zip tie straps although other means of attachment such as an adhesive could be utilized. The eye bolt (30) is used to hang the wreath on a wall, door or other flat surface. Faux fur or other material is affixed to the eye bolt (30) where the eye bolt is visible on the front side of the wreath using an adhesive or other means of attachment suitable to the material being utilized to disguise the eye bolt (30).

Decorative elements such as faux or dried natural flowers, vines, leaves, berries, plants, succulents, or ferns; seashells; wood bark; animal figurines; reindeer moss et. al, are then attached to the front of the wreath to create the fully adorned wreath. The faux materials may be made from plastic, silk, cloth, paper or other materials. Although preferred embodiments of the invention utilizes the aforementioned decorative elements, any number of decorative elements could be affixed to the front of the wreath.

Potential CPC patent classifications for this invention:
A41G 1/00—Artificial Flowers, Fruit, leaves or Trees; Garlands
A41G 1/04—Garlands; Assembly of Garlands

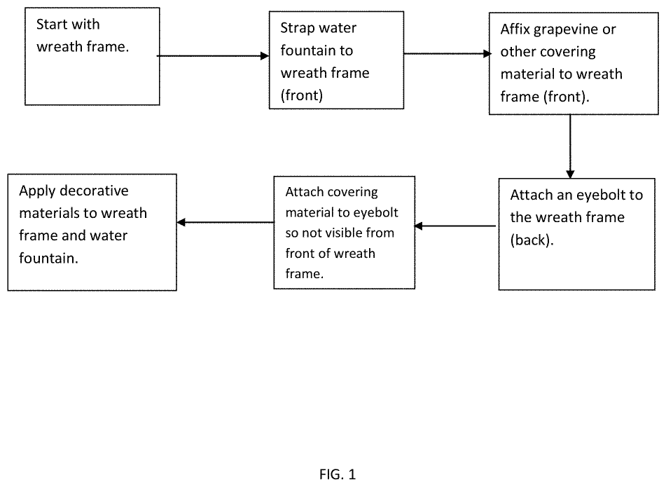

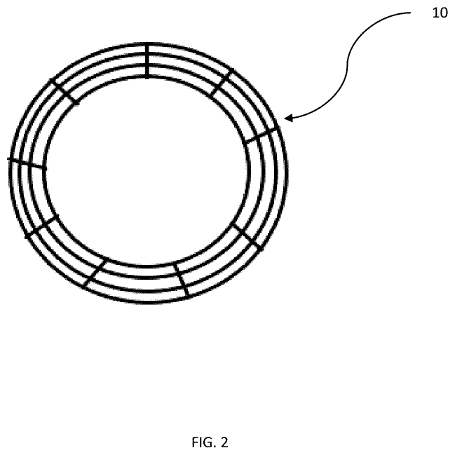

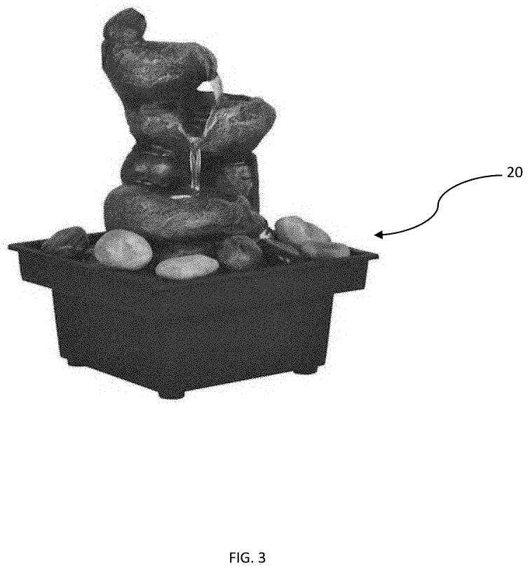

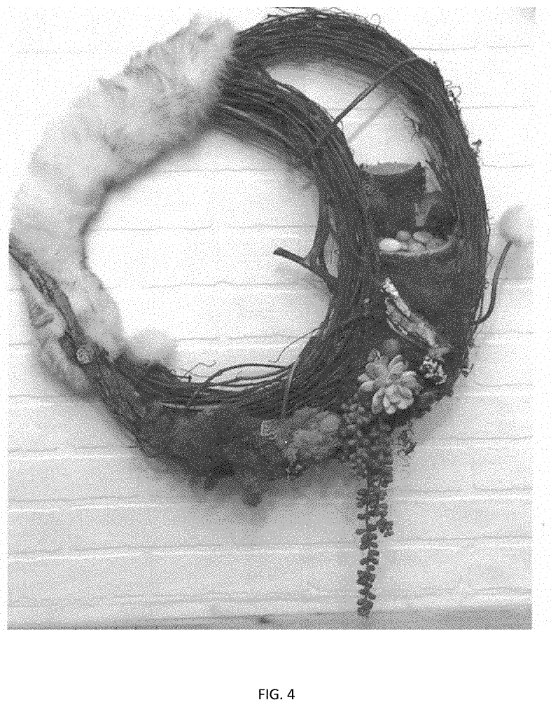

The present invention described above and illustrated in FIGS. 1 through 4 is visualized as the preferred embodiment of the invention. It is envisioned that this invention may be embodied in many different forms and should not be construed as limited to the embodiments set forth herein. It will be understood by those skilled in the art that changes in forms and details may be made without departing from the spirit and scope of the present application. It is therefore intended that the present invention not be limited to the exact forms and details described and illustrated herein but falls within the scope of the appended claims.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a stricture or feature that is disposed “adjacent” another feature may have portions that overlap or underlie the adjacent feature.

The invention claimed is:

1. A decorative wreath comprised of a wreath frame, miniature water fountain, an eye bolt for hanging the wreath and decorative elements including grapevine, tree bark, moss, reindeer moss, faux flowers, dried natural flowers, seashells, pebbles, stones, faux succulents, faux ferns, faux vines, faux plants, faux or dried natural vines, faux or dried leaves, faux fur, animal figurines.

2. A process form constructing a decorative wreath with a miniature water fountain comprised of the following steps:
Attach a miniature water fountain to a wreath frame;
Cover the wreath frame with grapevine or other decorative covering materials Affix an eye bolt to the wreath frame on the opposite side from the miniature water fountain.
Cover the exposed eye bolt with faux fur or other decorative materials by affixing the material to the eye bolt with an adhesive.
Affix decorative material to the wreath using adhesive, wires or straps where said decorative materials include grapevine, tree bark, moss, reindeer moss, faux flowers, dried natural flowers, seashells, pebbles, stones, faux succulents, faux ferns, faux vines, faux plants, faux or dried natural vines, faux or dried leaves, faux fur, animal figurines
